(19) United States
(12) Patent Application Publication
(10) Pub. No.: US 2022/0138179 A1
(43) Pub. Date: May 5, 2022

(54) PRIVATE BLOCKCHAIN SYSTEM AND METHOD

(71) Applicant: Blue Tech Inc., La Jolla, CA (US)

(72) Inventors: Guy Arnold Stone, La Jolla, CA (US); Alex Sukhikh, Oceanside, CA (US)

(73) Assignee: Blue Tech Inc., La Jolla, CA (US)

(21) Appl. No.: 17/087,151

(22) Filed: Nov. 2, 2020

(51) Int. Cl. G06F 16/23

(52) U.S. Cl. CPC G06F 16/2379

(57) ABSTRACT

A system, apparatus or method includes defining and creating a private blockchain that stores records or documents on a cloud storage by a predefined set of nodes, receiving a selection from a user node of a record or of a document for modification where the selection creates a flagged record or a flagged document, receiving a vote tally from among the predefined set of nodes, and modifying the record or document based on a consensus of the vote tally by adding an update block to the blockchain. The system, apparatus or method can further broadcast the update block to each node in the predefined set of nodes, add the update block to a local blockchain of each node, and present the flagged document or the flagged record as modified by the update block.

### CROSS-REFERENCE TO RELATED APPLICATIONS

Not applicable.

### BACKGROUND

The present disclosure is directed to a system and method for utilizing a private BlockChain system including a method of modifying or deleting documents or records on the BlockChain.

### DESCRIPTION OF THE RELATED ART

Public Block Chains, which are known primarily for supporting Crypto-currencies, are open to access by the general public and are available to any node that wishes to download the Blockchain. Critics of Public BlockChain believe that there is a privacy risk because everyone can download a Public BlockChain and access the history of transactions.

Private Block Chains (or permissioned Block Chains) are different from Public Block Chains, in that only authorized end-users can access the Private Blockchain. In Private BlockChain, nodes must be granted access to participate, view transactions, and deploy consensus protocols.

### BRIEF DESCRIPTION OF THE DRAWINGS

FIG. 1A illustrates a workflow diagram of a private Blockchain working on a cloud server in accordance with the embodiments;

FIG. 1B illustrates another workflow diagram of the private BlockChain of FIG. 1A in accordance with the embodiments;

FIG. 1C illustrates a flow chart of a balloting scheme for the private BlockChain of FIG. 1A in accordance with the embodiments;

FIG. 2 illustrates a system and method of Blockchain and document cloud storage access in accordance with the embodiments;

FIG. 3 illustrates a sample database file structure for linking on the Blockchain in accordance with the embodiments;

FIG. 4 illustrates methods of set up for the system and end users for enabling the uploading of documents or records associated with the private BlockChain in accordance with the embodiments;

FIG. 5 further illustrates a consensus algorithm for deleting, replacing or modifying a document or record in the private Blockchain in accordance with the embodiments;

FIG. 6A illustrates a representation of a block in the Blockchain being “deleted” in accordance with the embodiments and FIG. 6B illustrates sample code showing a subsequent block (Block 5) that the preceding block (Block 4) was “deleted”;

FIGS. 7A and 7B illustrate a user interface for looking up a document to be deleted and selecting the document to be deleted in accordance with the embodiments;

FIGS. 7C and 7D illustrate a user interface for selecting a document to be deleted and a storage status while the document is pending a consensus vote for deletion in accordance with the embodiments;

FIGS. 7E and 7F illustrate user interfaces for voting on whether to delete a selected document and confirmation that the vote has been sent in accordance with the embodiments;

FIGS. 7G and 7H illustrate user interfaces for viewing current vote counts enabling a user to change and re-send a vote and also view if the vote has been accepted or declined in accordance with the embodiments;

FIG. 7I illustrates a user interface where the deleted item is removed from the BlockChain documents list in the viewer in accordance with the embodiments;

FIG. 8A illustrates another flow chart for a consensus protocol for deletion or replacement of documents in accordance with the embodiments;

FIG. 8B illustrates another flow chart for a consensus protocol and synchronization in accordance with the embodiments;

FIGS. 9A, 9B, 9C, 9D, and 9E illustrate various screen prints of the user interface enabling a view of the documents in the private Blockchain, a view of the user nodes, a view of pending document votes, a document upload view, and a system log view among other views in accordance with the embodiments;

FIG. 10 is a flow chart of another voting algorithm and system in accordance with the embodiments; and

FIG. 11 is a block diagram of a system in accordance with the embodiments.

### DETAILED DESCRIPTION

In some embodiments, a system or method for a Private BlockChain utilizes a BlockChain algorithm to verify the integrity of a document or record. The program can be run by an organization that is in need of confirming that documents exist in their original unmodified state. Through a Private BlockChain, the organization can authenticate a document, much like a Notary Public authenticates a signature.

Because transactions listed on a Private BlockChain are private, they ensure an extra layer of confidentiality. Because Private BlockChain have restricted access, and nodes must be specifically selected to view and participate in a network, some argue that Private BlockChain grants more confidentiality to users. Private BlockChain are considered the most realistic way to adapt BlockChain technology into a business process in order to maintain a high level of confidentiality, however there are some disadvantages.

For example, Private BlockChain delegate specific actors to verify blocks and transactions. Although some argue that this provides efficiency and security, there are concerns that Private BlockChain are not truly decentralized because the verification of transactions and control are put back into the hands of a central entity.

The Private BlockChain disclosed herein, also referred to here as the “CYF4” BlockChain can typically consist of up to five nodes (although not necessarily limited to five); one admin node and up to four end-user nodes and up to ten “Viewer Nodes.” The first client to install the first copy for the group is the Admin. In most embodiments, the Admin then shares the account with up to four end-users by calling an API of the Enveloc app, which is an application that serves as a bridge to the cloud and a user interface to the information on the Private Blockchain. A consensus algorithm will require up to 51% (or other predetermined percentage) of the nodes to confirm the validity of a document. The Viewer nodes will not be able add, modify or delete documents to the Block Chain; they will instead be able to only review, email and/or print documents that exist in the Block Chain.

The admin node will keep track of the voting for each document. This record will be available for review in order to confirm validity of a documents inclusion into the CYF4 BlockChain.

The admin and end-user nodes will all have the latest version of the CYF4 BlockChain hash code. The only requirement for each node will be to maintain a copy of the CYF4 BlockChain code. Nodes do not need to store any document(s) locally. Through an app created by Enveloc, the CYF4 BlockChain code will point to a document in the cloud. Each of functions of the app is available through an API routine or can be operated through a GUI.

The Admin Node can obtain its credentials by applying for an account on Enveloc's or the app's web site, which creates the account and forwards credentials to the User, partly by email and partly though SMS text messaging to create an effect similar to two-factor authentication.

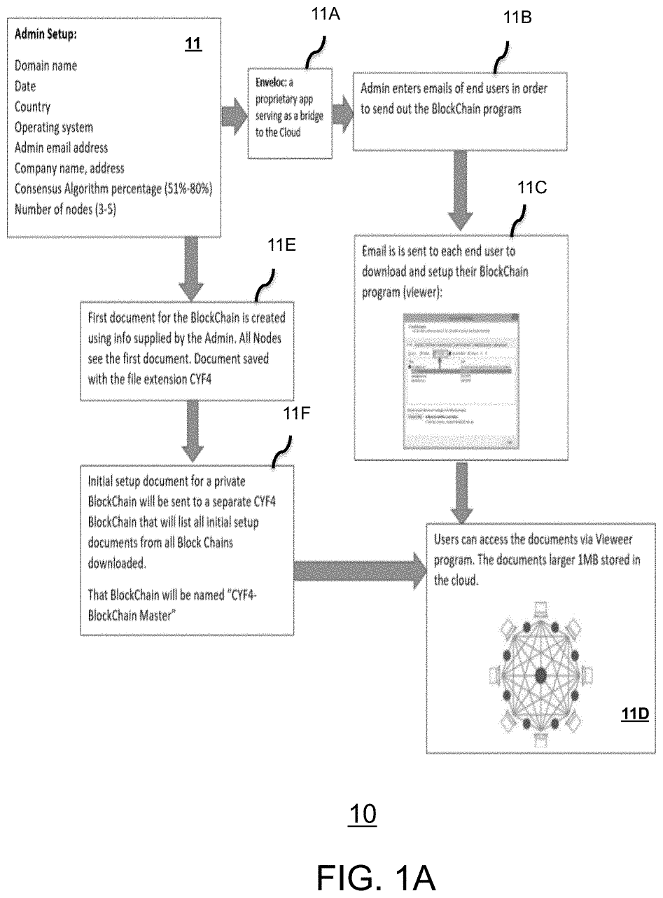

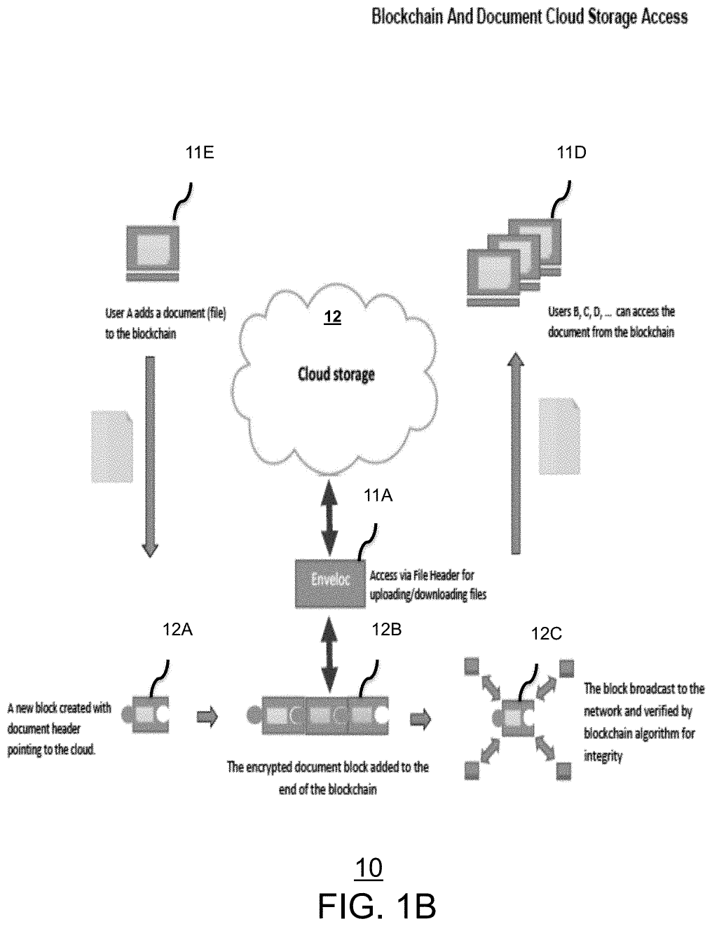

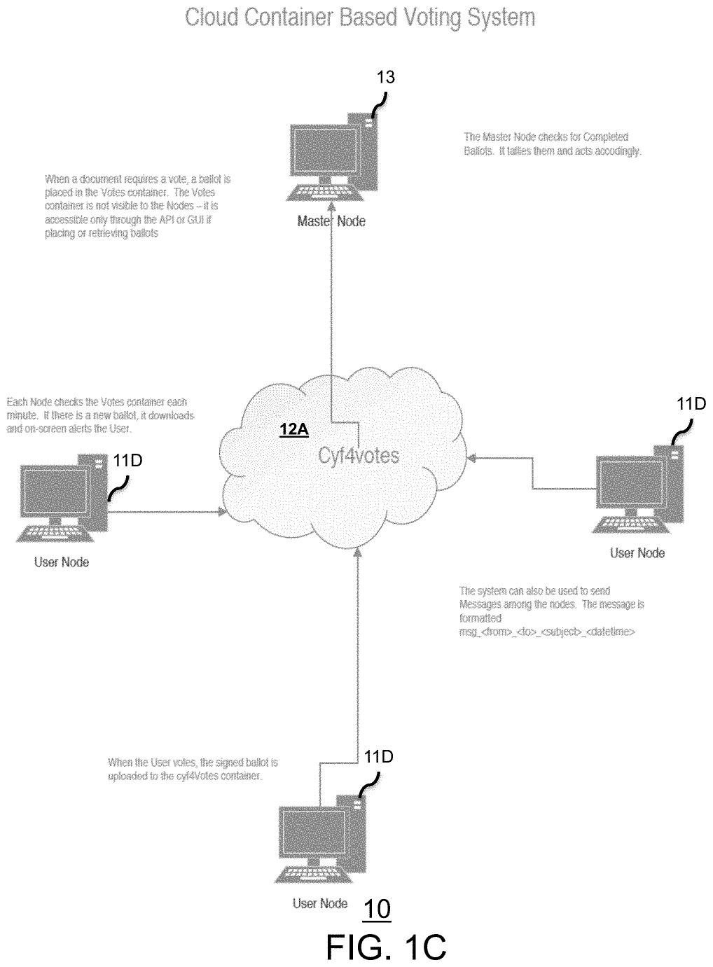

Referring to the system 10 of FIG. 1A, a private blockchain in accordance with some of the embodiments can include an Administrator or Admin setup 11 that includes pertinent information including domain name, date, country, operating system, Admin email address, Company name and address, consensus algorithm percentage setting (51%-80%, for example) and the number of nodes setting (typically 3-5). Using a proprietary app such as Enveloc at 11A, the system 10 can then enable the Admin to enter emails of End Users in order to send out the Private Blockchain program to such End Users at 11B. At 11C, the email is sent to each End User to download and setup their Private BlockChain viewer program. At 11D, End Users can then access the documents in the Private BlockChain via the viewer program (Enveloc). The documents larger than a predetermined size (such as 1 MB) can be stored in the cloud or alternatively all documents can be stored in the cloud. At 11E, the first document for the private blockchain is created using information supplied by the Admin which is viewable by all nodes. In these embodiments, the document is saved with the file extension “CYF4”, but other embodiments within the scope of the claims can have other file extensions.

Referring to the system 10 of FIG. 1B, another illustrated view shows how documents are added, accessed, and viewed from cloud storage 12 via the Enveloc app or viewer 11A. The viewer 11A enables access via file header for uploading and downloading files. As before, User A adds a document or file to the blockchain at 11E and a new block is created at 12A with a document header pointing to a storage location in the cloud storage 12. At 12B, the encrypted document block is added to the end of the blockchain and then broadcast to the network of users and verified by the blockchain algorithm for integrity at 12C. The other authorized users (such as Users B, C, and D) can now access the document from the blockchain.

Referring to FIG. 1C, in some embodiments the system 10 further includes a cloud container based voting system that can be used for document management including the “deletion” or “substitution” of documents on the private blockchain. When a documents requires a vote, a ballot is placed in the “votes container” which is illustrated as the Cyf4votes 12A residing in the cloud 12 (see FIG. 1B). Each user node 11D checks the votes container 12A periodically such as every minute. If there is a new ballot, the user node 11D downloads the ballot and provides an on-screen alert for the user. When a particular user node 11D votes, the signed ballot is uploaded to the Cyf4votes container 12A. The system 10 can also be used to send messages among the user nodes where the message can be formatted, for example, as msg_<from>_<to>_<subject>_<datetime>. The master node 13 can check for completed ballots. The master node 13 then tallies the ballots and acts accordingly.

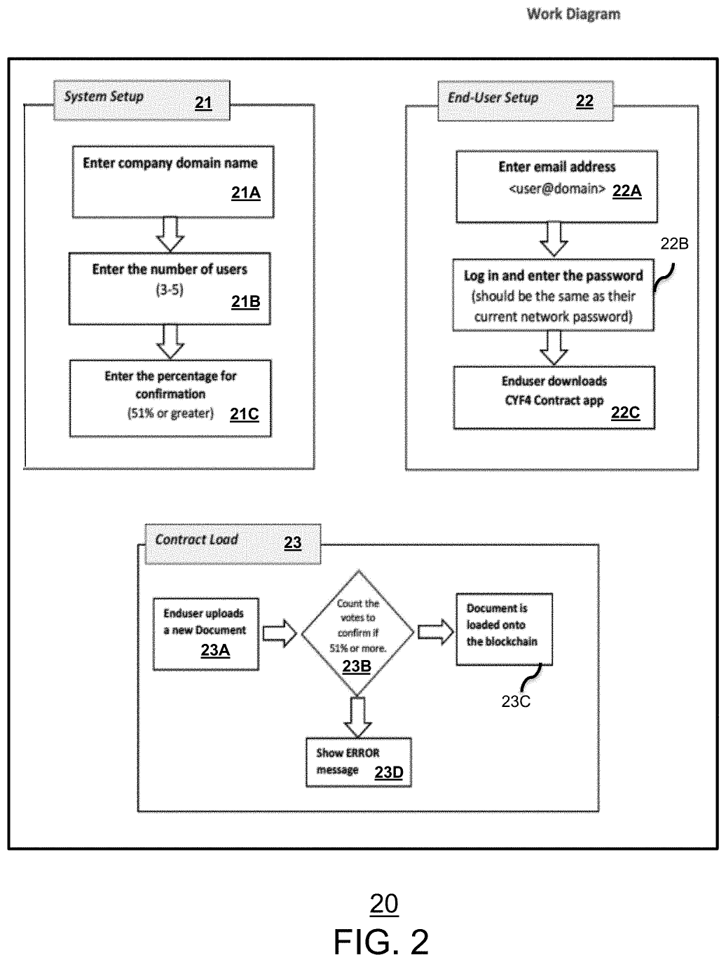

Referring to FIG. 2, a flow diagram 20 illustrates a sample system setup 21, end-user setup 22, and contract or document uploading process 23 in accordance with some of the embodiments. With respect to the system setup 21, the process begins with entering a company domain name at 21A, entering at 21B a number of users for the company (for example, 3 to 5 users are selected and entered), and entering at 21C a percentage for confirmation of document management or handling. In this example, the system user a scheme of 51% or greater. In some embodiments the end user setup 22 involves entering at 22A an email address (such as the format <user@domain>. The user can then login and enter a password at 22B and further download the CYF4 contract app at 22C. The uploading process 23 can start with an end user uploading a new document at 23A and the system counting votes at 23B to confirm a majority vote or 51% or more to upload the document onto the blockchain at 23C. If insufficient confirming votes (within a predetermined time period) or the vote tally up to fail to have a majority vote, then an error message is shown at 23D.

In summary, FIG. 2 illustrates a particular embodiment for private BlockChain and document cloud storage access system and system setup that will be known as the CYF4 program. The CYF4 admin node is created with background information on the Admin user to include company, domain name, and contact information. The Admin user can then enter emails for User and Viewer nodes to whom a CYF4 program will be sent and downloaded. Admin and User nodes will then be able to enter and vote to include, modify or delete documents. Viewer Nodes can be enabled to view, print and email documents (but not add or delete documents).

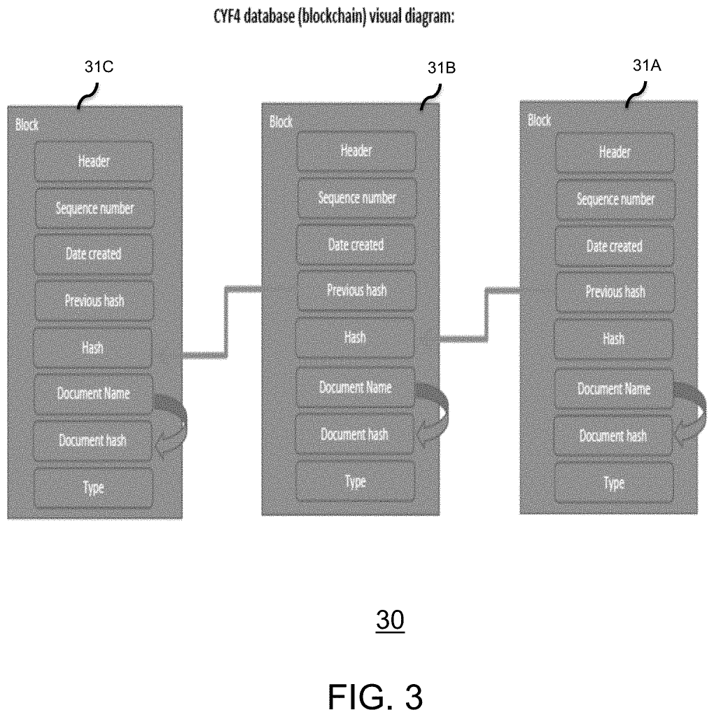

In some embodiments, FIG. 3 illustrates a more detailed view of a blockchain 30 with interconnected or linked blocks 31A, 31B, and 31C. Each block can have a format that includes fields for a header, sequence number (number the document is in the blockchain), date of creation, a hash code of the previous block chain, a hash code for a current block chain, a document name (with a CYF4 file extension name in the case of the CYF4 program), a hash code of the document (unique to the CYF4 Block Chain algorithm), and a document type (which can include contracts, awards, tax documents or other file types. Each previous hash field of a preceding block points to a current hash of a succeeding block. Also, each document name within a block is used to provide a document hash within the same block.

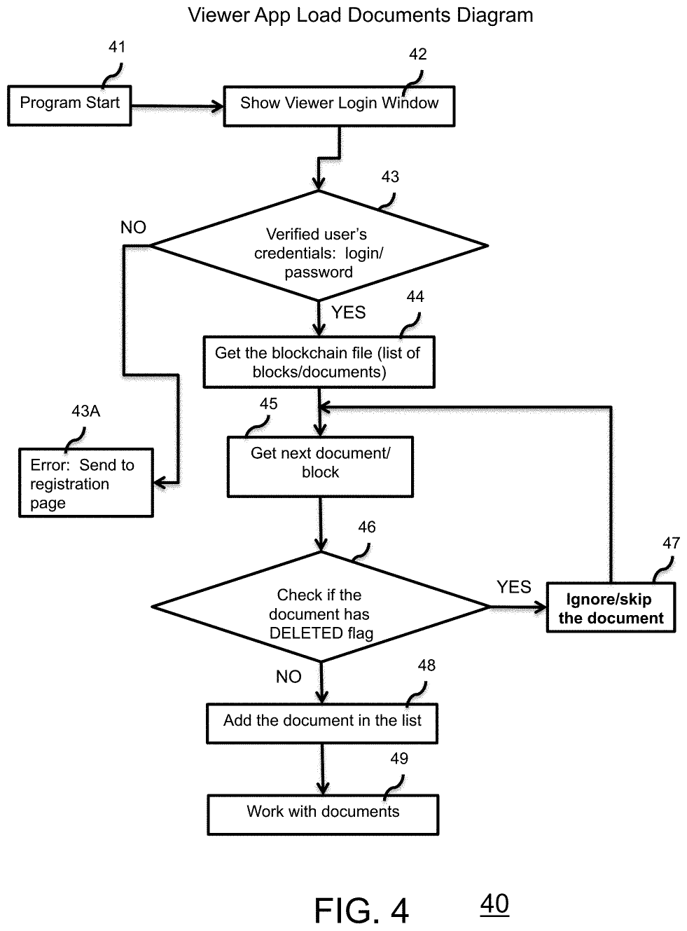

In some embodiments, a viewer app document loading method 40 as shown in FIG. 4 includes starting the program at 41, displaying a viewer login window at 42 and verifying the user's credentials (login name and password, etc.) at decision block 43. If the credentials are not verified at decision block 43, then an error message is sent and optionally displayed to the registration page at 43A. If the credentials are verified at decision block 43, then the blockchain file (including the list of blocks and documents) are obtained at block 44. As the user obtains or gets the next document or block at 43, the method 40 checks if the document has a “DELETED” flag at decision block 46. If the document does have the DELETED flag at decision block 46, then the document is skipped or ignored at 47 and the method loops back to getting the next document or block at 45. If the document does not have the DELETED flag at decision block 46, then the next document (obtained at 45) is added to the list at block 48. The viewer can then work with the documents at 49.

In summary, FIG. 4 illustrates a method of enabling end user to upload documents and records associated with the private BlockChain. Admin or User Nodes can open the Viewer window. User credentials are accepted (or rejected if not authorized). If credentials are accepted a User at a User node can view the documents in the cloud and have the ability to add, modify or delete documents.

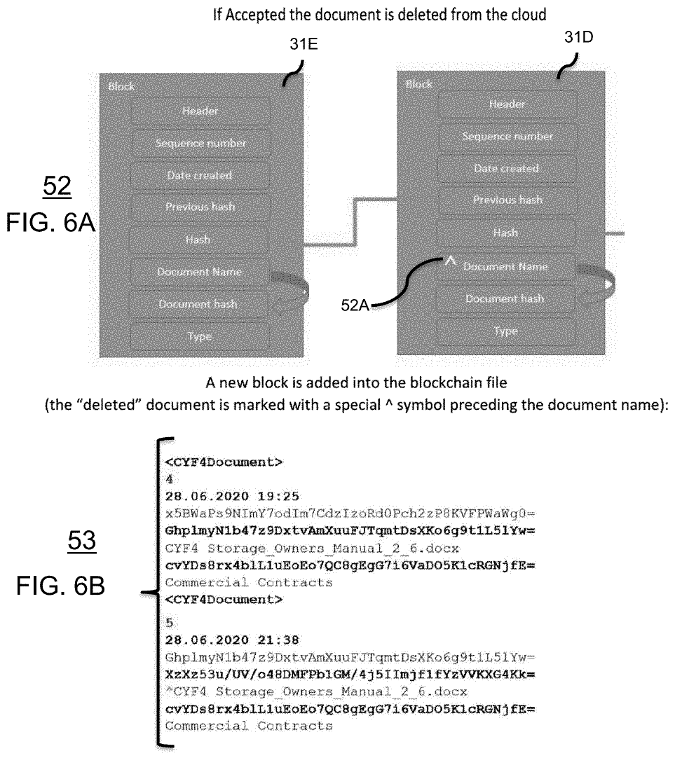

A request to modify, add or delete a document in the cloud can be made by any of the User nodes. A modification or deletion would also have to be confirmed by the consensus algorithm. Once an agreement has been reached by consensus, the original document will be deleted from the cloud by placing a “marker” on the name of the document. (See FIG. 6a.) The CYF4 BlockChain hash code on the nodes however will not be altered whatsoever; the CYF4 BlockChain will now instead point to a blank “null” value in the cloud where the original document used to exist. A new block will be added to the CYF4 Blockchain code documenting the modification or deletion of the original document. If there is a now a modified document, the new block in the CYF4 Blockchain will point to the modified document that exists in cloud storage.

A list of documents that have been loaded into the cloud can also be viewed and sorted by the CYF4 “Viewer,” (in addition to the Admin and User Nodes). The Viewer will be able to sort documents or files in the cloud by date, type of file, end date for the file (if it is an agreement with a termination date), or by whatever criteria entered by the admin node.

Referring to FIGS. 1a, 1b and 1c, High level flow charts illustrate the work process and the module integration used with the private CYF4 BlockChain. Users add documents to be voted into the CYF4 Block Chain; document is added via consensus vote; Block Chain hash code is created and points to the document that is loaded into the cloud.

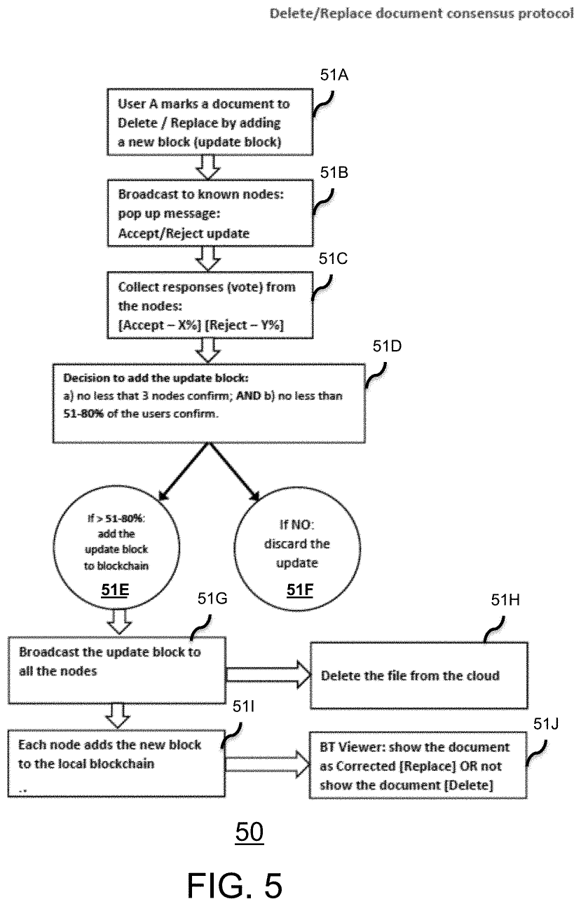

The method 50 of FIG. 5 illustrates a sample method of deleting or replacing documents using a consensus protocol in accordance with the embodiments. At block 51A, a user “A” such as an Admin node or user node can mark a document to delete or replace by adding a new block (an update block). Next, at 51B, the update block is broadcast to known nodes providing a messages such as a pop up message requesting a vote whether to accept or reject the update block. At 51C, the system collects responses (votes) from the nodes and can determine a percentage or count of accepted and rejected votes. Depending on the predetermined parameters set up for the system, the decision to add or not to add the update block is made at 51D. In one arrangement, the parameters could require that no less than 3 nodes confirm and that no less than 51-80% of the users confirm. Based on the parameters, the update block is either added to the blockchain at 51E or the update block is discarded at 51F. If the update block is added, the system broadcasts the update block to all nodes at 51G. If the update is for a deletion, then the system deletes the file from the cloud at 51H. In any case where the update block is added, each node adds the new update block to their local blockchain at 51I. The viewer program at 51J will then show the document as corrected when replacing (using the update block) or will not show the document at all when being deleted (again, using the update block).

FIG. 6A illustrates how the method of deleting a document or record in the private Blockchain would impact the actual blocks (31D and 31E) in the block chain 52 in accordance with the embodiments. As noted above, a document to be deleted is selected by either the Admin or User node, a consensus vote is taken to remove the document from the Block Chain, with a consensus vote such as a 51% vote to delete. When the consensus vote to delete is achieved, a marker “\hat{ }” 52A is appended to the front of the document name in the hash code file. The marker will make the BlockChain point to a “null” value in the cloud, effectively removing the document from the BlockChain list of documents.

FIG. 6B illustrates some sample code 53 showing a subsequent block (Block 5) that the preceding block (Block 4) was “deleted′.

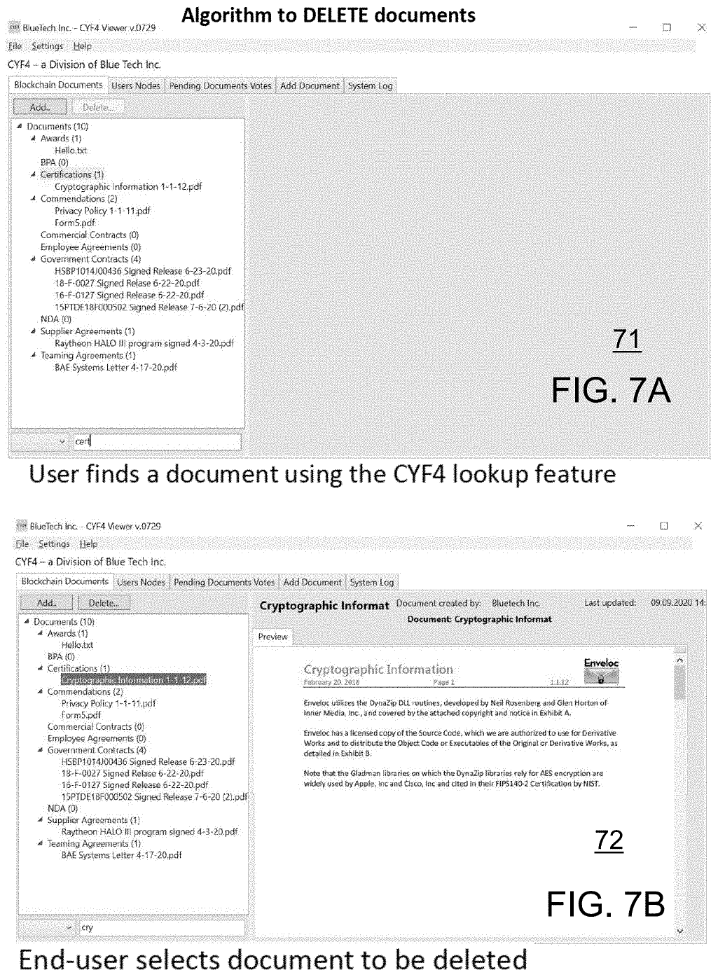

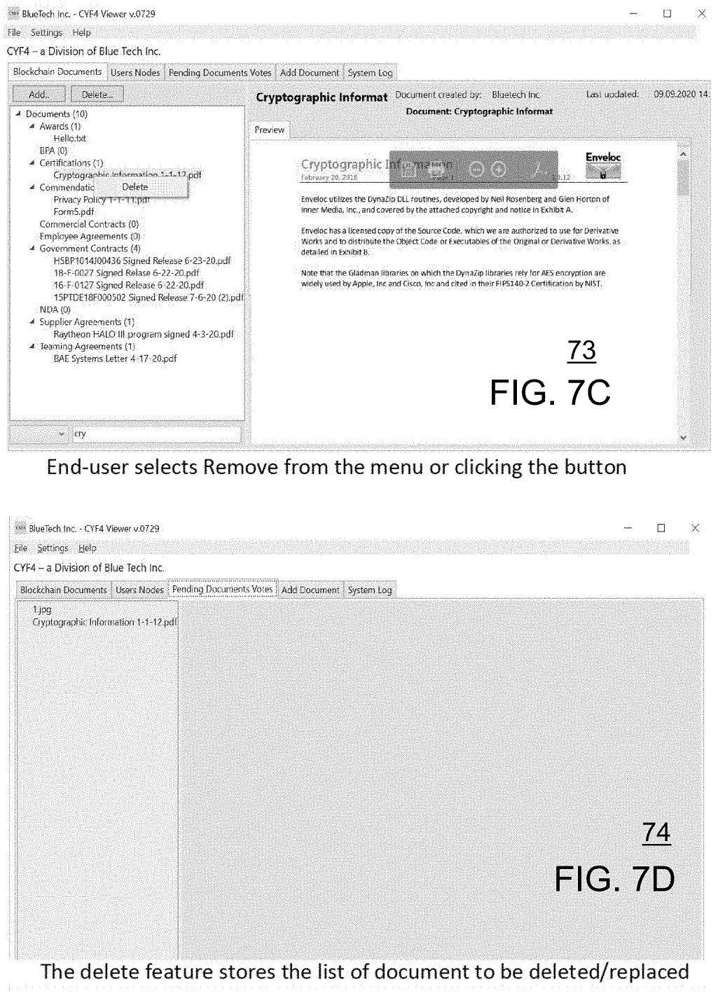

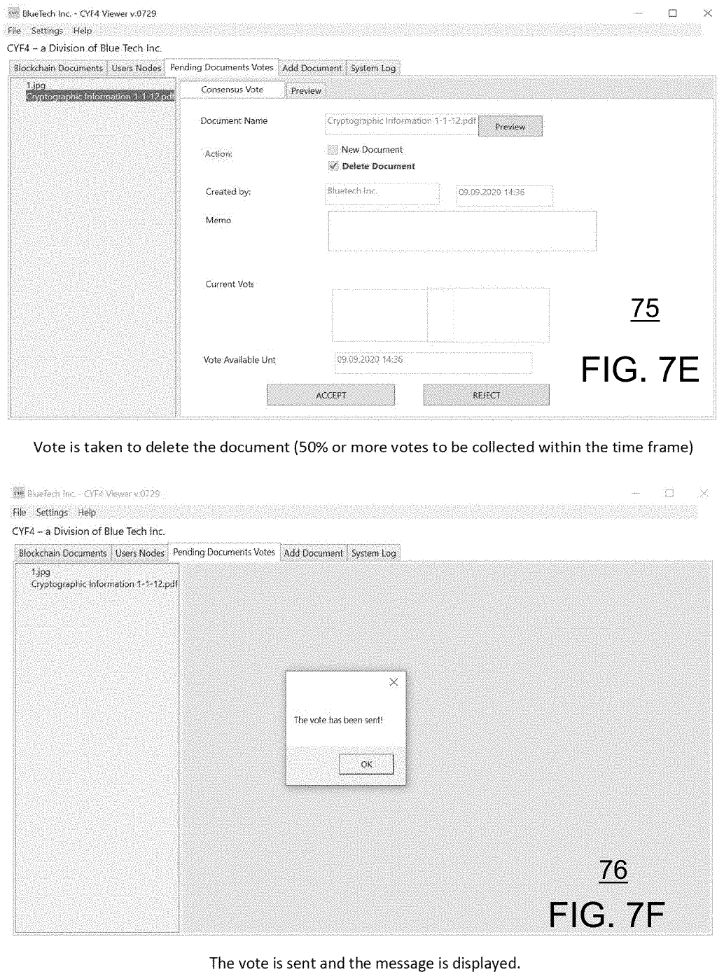

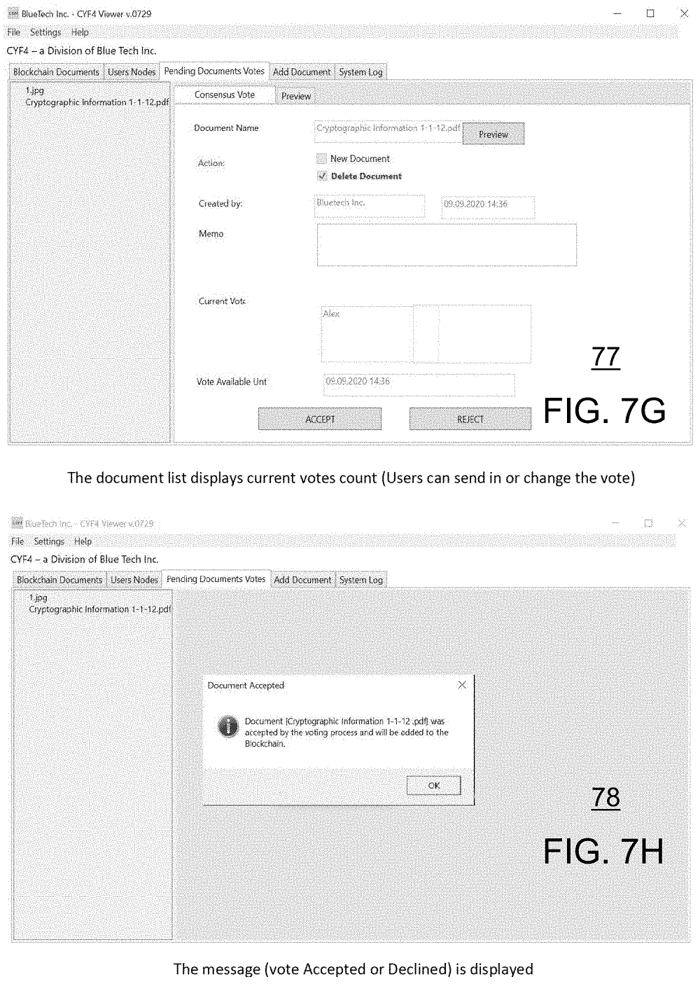

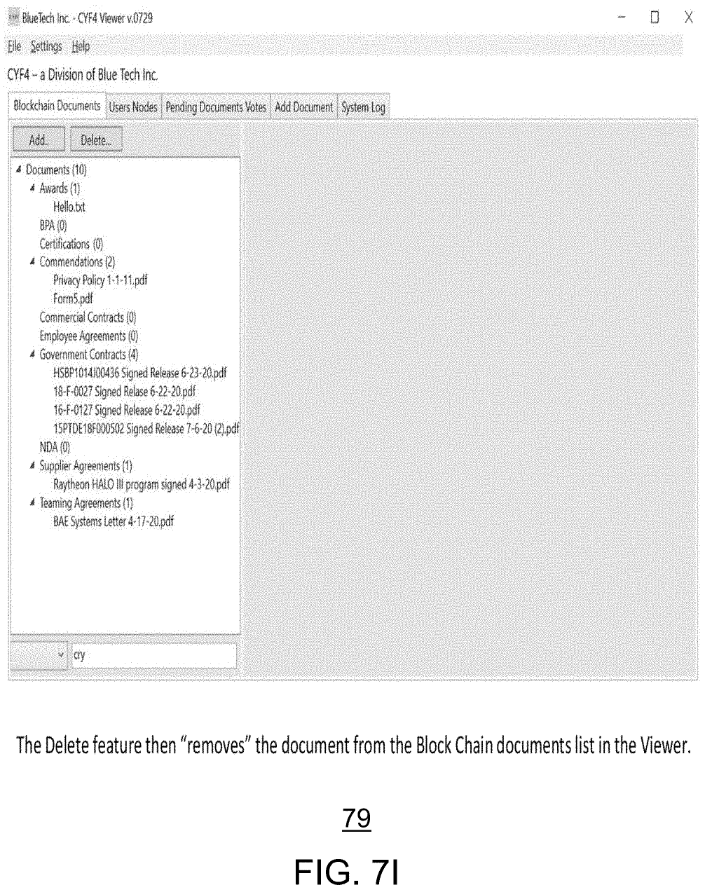

FIGS. 7A-I illustrate some sample user interfaces that include various tabs that enable a user to find and select documents or files for deleting, replacing or modifying within the private blockchain. In some embodiments, the viewer can include tabs showing the documents in the blockchain, the user nodes, the pending votes for documents to be deleted, replaced or modified, the documents to be added, and a system log.

FIG. 7A illustrates a user interface 71 showing how a user would find a particular document using a lookup feature of the user interface 71. FIG. 7B further illustrates the user interface 72 once the end user selects the document to be operated upon (deleted). FIG. 7C shows a user interface 73 where the user selects to delete or remove the document from the menu or list. Once a document is selected, the selected document can then be found listed in the user interface 74 of FIG. 7D under the “Pending Documents Votes” tab where a list of documents to be deleted or replaced is kept. If the document is selected under the “Pending Document Votes” tab as shown in the user interface 75 of FIG. 7E, then a vote can be taken to delete the document by checking an action box to deleted the document as shown. If the voting action is accepted by the user, the system will display a message that the vote has been sent in the user interface 76 of FIG. 7F. The user interface 77 of FIG. 7G displays the document list with the current vote counts where the user can send in or change their vote. Once the vote has been completed, the system displays a message on user interface 78 of FIG. 7H reflective of the results of the vote results. If the vote was in the affirmative to “delete” the document (in this case under “Certifications”), the user interface 79 in FIG. 7I shows that the document has been removed from the block chain documents list in the viewer since there are “0” documents listed under “Certifications”, whereas in FIGS. 7A and 7B there was one (1) document shown under “Certifications”.

In summary, FIG. 7A-I illustrates a a particular consensus algorithm for deleting, replacing or modifying a document or record in the private Blockchain in accordance with the embodiments. The figures show the steps the user will take to delete a document from the cloud. The End user selects the document to be deleted, the CYF4 program stores the list of documents to be deleted or replaced, and a vote is taken to delete the document. In some embodiments, the Vote must be 50% or more for consensus within a specific time frame. The Vote is sent and message is displayed—“Vote has been sent.” The document list displays a current votes count and message saying that the vote to delete has been accepted. See display of BlockChain hash code in FIG. 6A that shows a \hat{ }placed in front of the document name, making the document unreadable by the CYF4 viewer program, (thus deleted from the list of viewable documents.) A new block is added to the BlockChain file showing the BlockChain hash code. See hash code number 5 in the illustration showing that hash code number 4 was deleted.

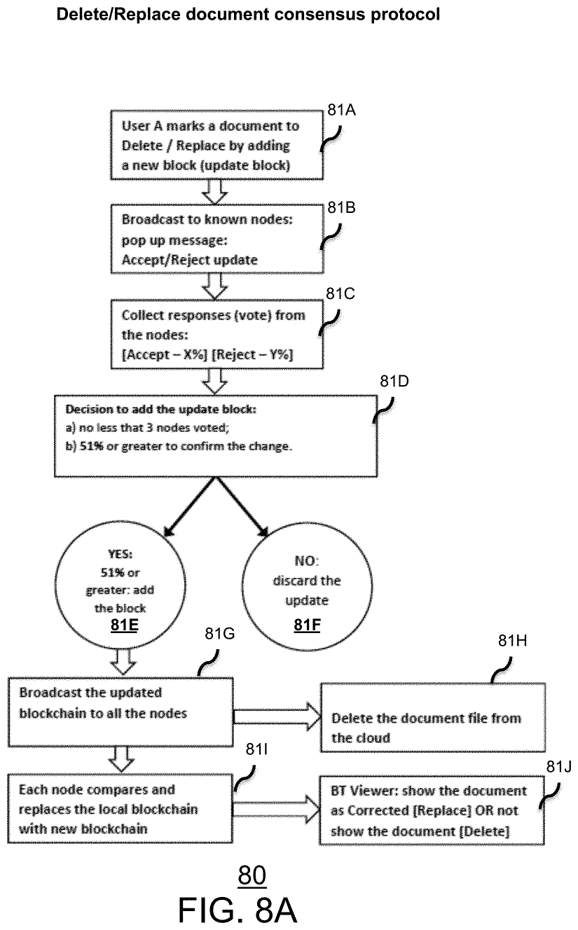

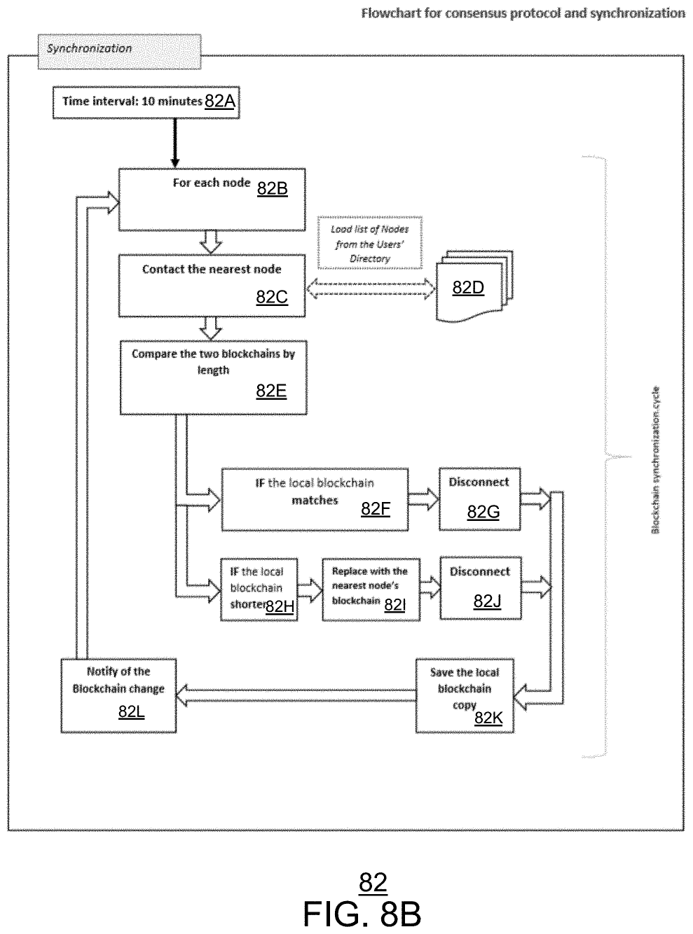

The method 80 of FIG. 8A illustrates another sample method of deleting or replacing documents using a consensus protocol in accordance with the embodiments. At block 81A, a user “A” such as an Admin node or user node can mark a document to delete or replace by adding a new block (an update block). Next, at 81B, the update block is broadcast to known nodes providing a messages such as a pop up message requesting a vote whether to accept or reject the update block. At 81C, the system collects responses (votes) from the nodes and can determine a percentage or count of accepted and rejected votes. Depending on the predetermined parameters set up for the system, the decision to add or not to add the update block is made at 81D. In one arrangement that is slightly different from 51D of FIG. 5, the parameters could require that no less than 3 nodes confirm and that no less than 51% of the users confirm. Based on the parameters, the update block is either added to the blockchain at 81E or the update block is discarded at 81F. If the update block is added, the system broadcasts the update block to all nodes at 81G. If the update is for a deletion, then the system deletes the file from the cloud at 81H. In any case where the update block is added, each node adds the new update block to their local blockchain at 81I. The viewer program at 81J will then show the document as corrected when replacing (using the update block) or will not show the document at all when being deleted (again, using the update block).

FIG. 8B illustrates a flow chart for a consensus protocol and synchronization method 82 in accordance with the embodiments. The delete and/or replace document consensus protocol or method 82 shows that a user marks a document to be deleted, broadcasts a message to accept or reject the request. If more than 50% (or other predetermined majority percentage) accept, then the document is marked with a \hat{ } symbol in the front of the document name. The document is then deleted from the cloud.

In terms of synchronization, a pretermined time interval is set at 82A and for each node at 82B, the node contacts the nearest node at 82C and the nearest node also receives a list of nodes from a User Directory 82D. A comparison is then done at 82E that compares the local blockchain length of a user node with the local blockchain length of a contacted nearest contact node. If the local blockchains (of the node and the nearest node) match in length at 82F, then the node disconnects at 82G and the local blockchain copy is saved at the node at 82K and subsequently each node is notified of the blockchain change at 82L. If the local blockchain is shorter (than that of the nearest node) at 82H, then the nearest node's blockchain replaces the node's blockchain at 82I. The node disconnects at 82J and the local blockchain copy is saved at the node at 82K and subsequently each node is notified of the blockchain change at 82L.

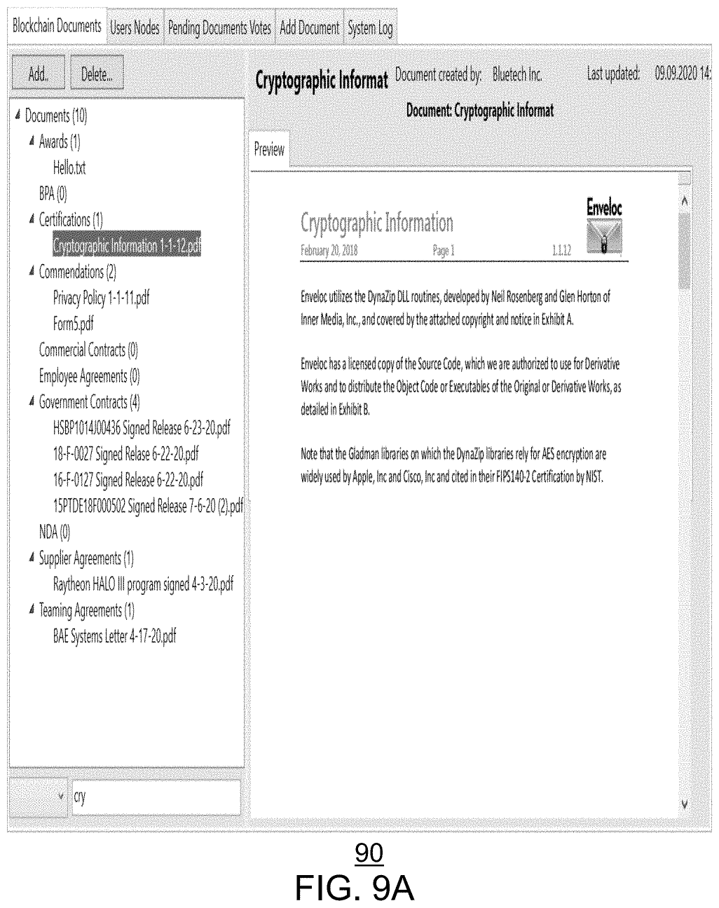

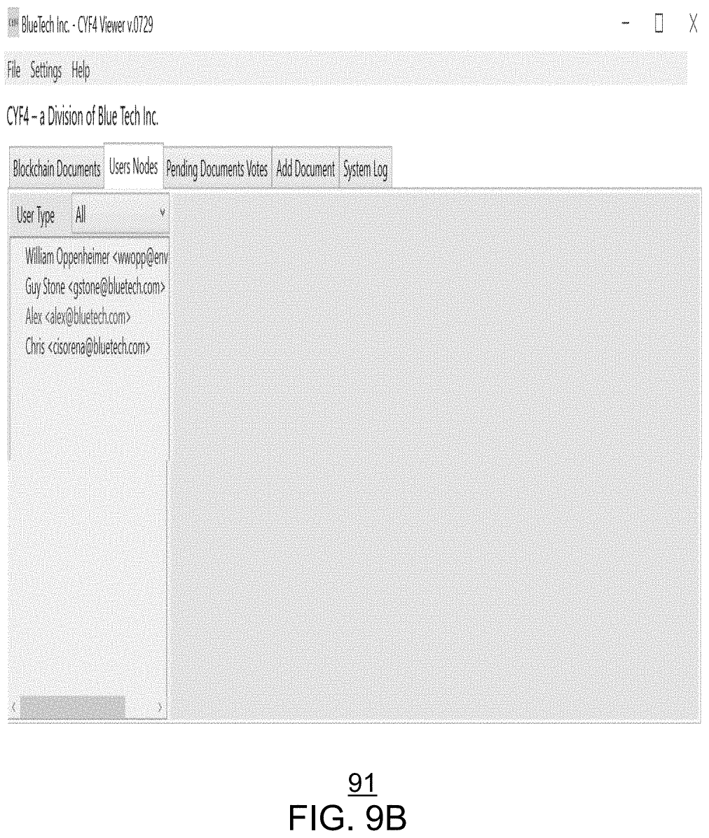

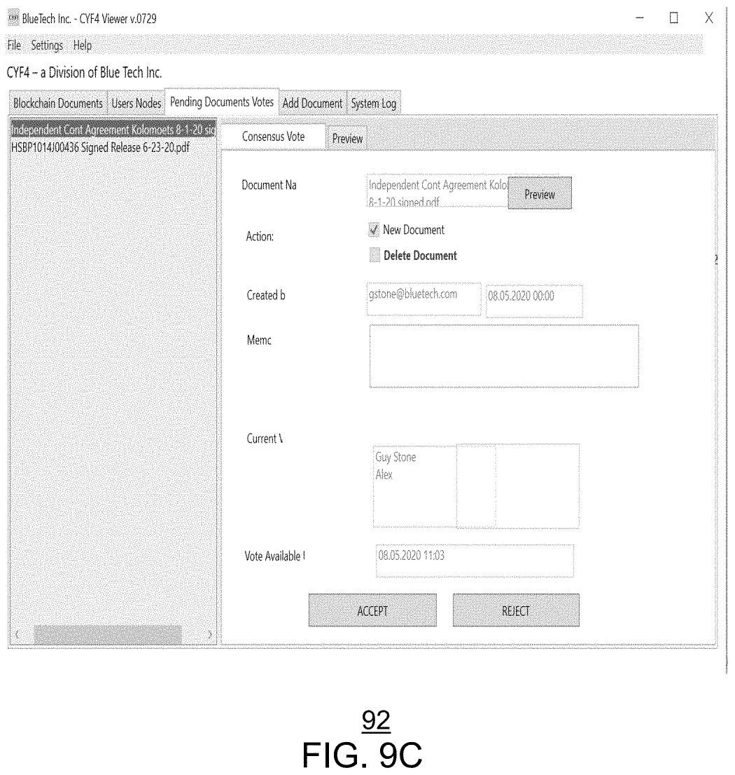

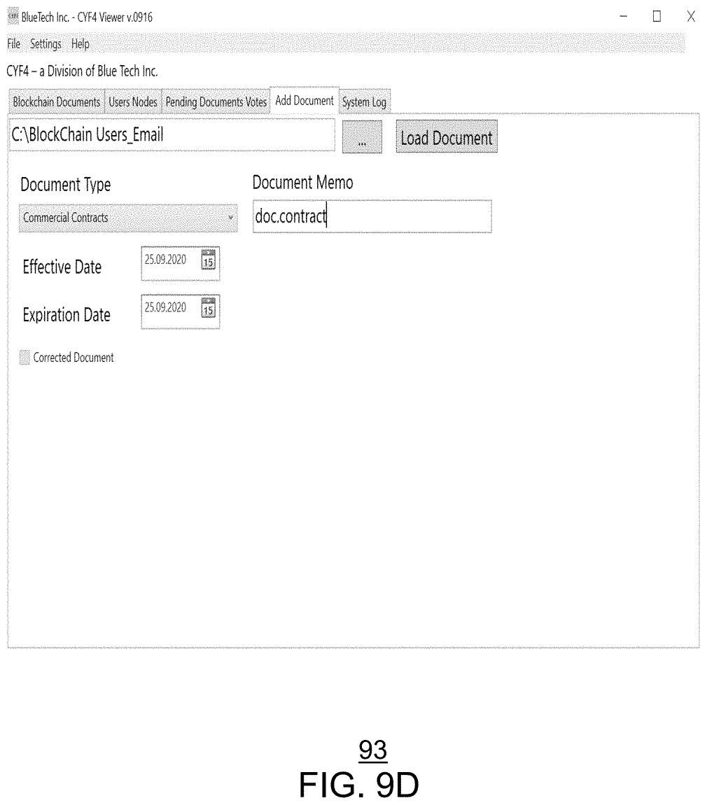

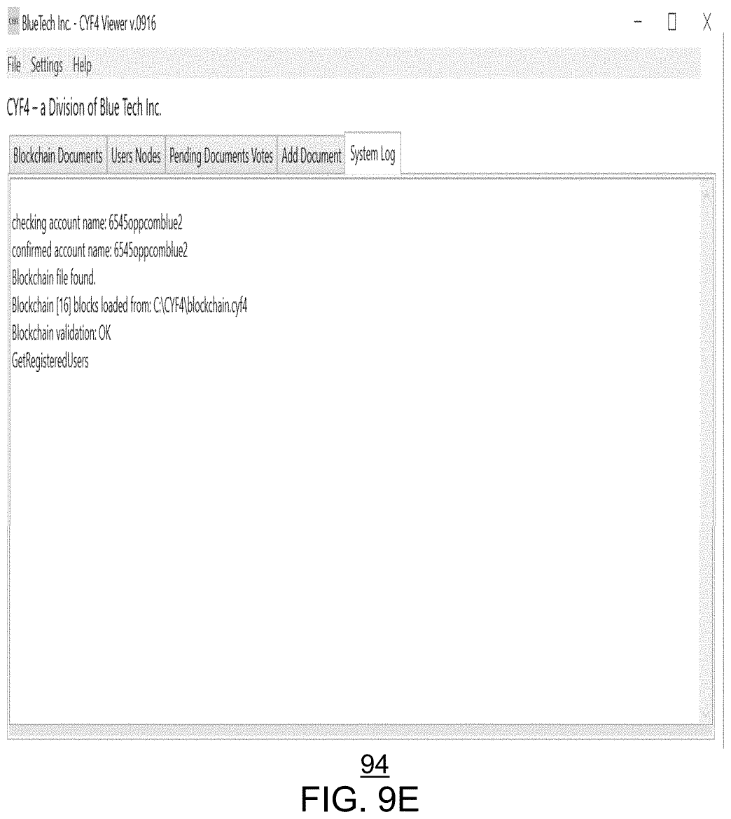

FIGS. 9A, 9B, 9C, 9D and 9E illustrate various screen prints of the user interface enabling a view of the documents in the private Blockchain, a view of the user nodes, a view of pending document votes, a document upload view, and a system log view respectively among other views in accordance with the embodiments. More particularly, FIG. 9A shows a listing of documents in the Cloud as seen on a user interface 90 by a viewer such as the CYF4 Viewer; FIG. 9B illustrates a user interface 91 with a list of Viewer Nodes; FIG. 9C shows a user interface 92 with a list Pending Votes in a consensus voting for adding, deleting or modifying a document or file; FIG. 9D demonstrates a user interface 93 showing a view for uploading documents; and FIG. 9E shows a user interface 94 with a System Log Report.

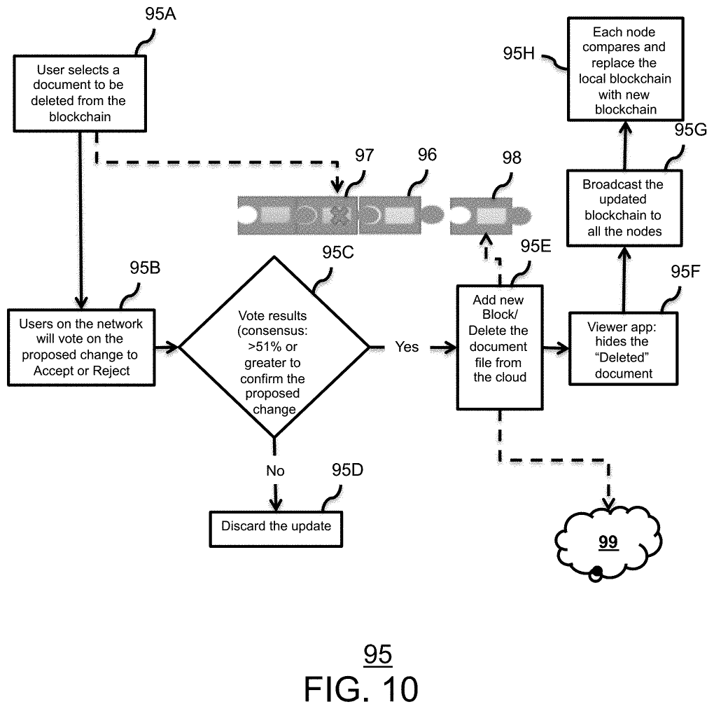

FIG. 10 is another system and algorithm 95 showing the CYF4 consensus algorithm enabling end users to vote (approve or reject) a proposed change in the blockchain. The proposed change can be to add, modify, or remove a document or file. The unique technology to remove a document is a special block added to the blockchain to mark a specific block as “Deleted”. This “Deleted” block will stay in the blockchain, but will not be shown in the User Interface or viewer program. More particularly, the algorithm 95 begins by having a user select a document 97 to be deleted from the blockchain 96 at 95A. The users on the network vote on the proposed change to accept or reject the proposed change at 95B. At decision block 95C, the vote results are tallied and if no consensus vote is obtained at 95C, then the update is discarded at 95D. If the consensus vote is obtained confirming the proposed change at 95C, then a new block 98 is added at 95E to “delete” or “change” the document from the cloud 99. At the viewer app, the viewer app's user interface hides the “deleted” document at 95F and the updated blockchain is broadcast to all the nodes at 95G. As further detailed with respect to FIG. 8B, each node then compares and replaces at 95H the local blockchain with the new or updated blockchain.

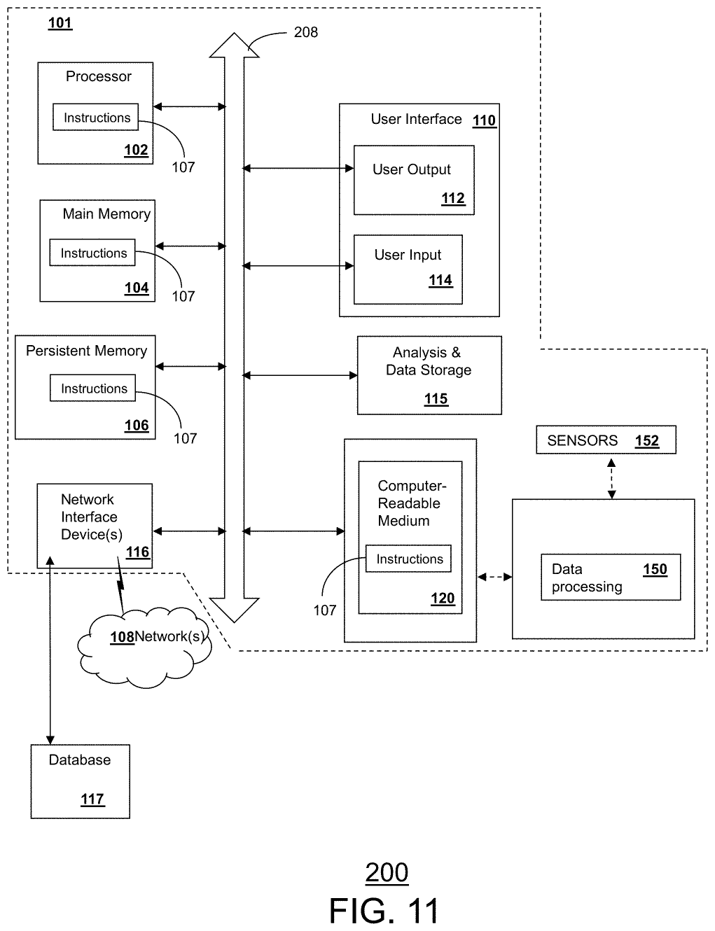

In some embodiments, and with further references to FIG. 11, a system 200 for a private blockchain can include any number and combination of the previously described components above as well as one or more processors which when executing the computer instructions, performs the functions of modifying a document on a private blockchain such as deleting, changing, or adding a document on a blockchain using a consensus and synchronization algorithm among predetermined users on user nodes of the system.

In some embodiments, the system can utilize artificial intelligence and more particularly machine learning which can use exemplary training data and/or actual commercial use data to further refine what is intended to serve as an exemplary repetition based on a particular environment or a number of known environments. Machine learning is a method of data analysis that automates analytical model building. It is a branch of artificial intelligence based on the idea that systems can learn from data, identify patterns and make decisions with minimal human intervention. Some of the training data that can be used to help identify patterns and make decisions can include fields such as identity codes, scheduling data, location data and/or other parameters obtained from sensors such as cameras, video monitoring devices, audio devices, temperature or other sensor data that can be programmatically configured to more adequately and accurately reflect real world conditions as a system is utilized in a particular environment and hopefully across different environments. Ideally, using machine learning enables systems to automatically learn and improve from experience without being explicitly programmed. Machine learning in the embodiments herein can focus on the development of computer programs (using the Python programming language, for example) to access data and use it to learn for itself in order to better predict how a particular user and user node should vote with respect to documents or files that may be modified, added or deleted on a private blockchain as discussed above.

In some embodiments, the system can be a client device having one or more computer storage mediums containing computer instructions enabling secure access and one or more processors operationally coupled to the one or more computer storage mediums where the one or more processors perform the operations described above.

In some embodiments, the system can further include a computer-storage media coupled to a processor (or processors) and computer-executable instructions embodied in the computer-storage media that, when executed by one or more computing devices, perform a method that perform any number of steps such as performing the consensus voting and synchronization or algorithm method.

Various embodiments of the present disclosure can be implemented on an information processing system. The information processing system is capable of implementing and/or performing any of the functionality set forth above. Any suitably configured processing system can be used as the information processing system in embodiments of the present disclosure. The information processing system is operational with numerous other general purpose or special purpose computing system environments, networks, or configurations. Examples of well-known computing systems, environments, and/or configurations that may be suitable for use with the information processing system include, but are not limited to, personal computer systems, server computer systems, thin clients, hand-held or laptop devices, notebook computing devices, multiprocessor systems, mobile devices, microprocessor-based systems, set top boxes, programmable consumer electronics, network PCs, minicomputer systems, mainframe computer systems, Internet-enabled television, and distributed cloud computing environments that include any of the above systems or devices, and the like.

For example, a user with a mobile device may be in communication with a server or cloud storage configured to implement the system using the aforementioned elements, according to an embodiment of the present disclosure. The mobile device can be, for example, a multi-modal wireless communication device, such as a “smart” phone, configured to store and execute mobile device applications (“apps”) such as the viewer app enabling users to set up other user nodes and administer a voting or consensus algorithm for modifying or deleting documents from a private blockchain. Such a wireless communication device communicates with a wireless voice or data network using suitable wireless communications protocols.

The system may include, inter alia, various hardware components such as processing circuitry executing modules that may be described in the general context of computer system-executable instructions, such as program modules, being executed by the system. Generally, program modules can include routines, programs, objects, components, logic, data structures, and so on that perform particular tasks or implement particular abstract data types. The modules may be practiced in various computing environments such as conventional and distributed cloud computing environments where tasks are performed by remote processing devices that are linked through a communications network. In a distributed cloud computing environment, program modules may be located in both local and remote computer system storage media including memory storage devices. Program modules generally carry out the functions and/or methodologies of embodiments of the present disclosure, as described above.

In some embodiments, a system includes at least one memory and at least one or more processor of a computer system communicatively coupled to the at least one memory. The at least one processor can be configured to perform a method including methods described above.

According to yet another embodiment of the present disclosure, a computer readable storage medium comprises computer instructions which, responsive to being executed by one or more processors, cause the one or more processors to perform operations as described in the methods or systems above or elsewhere herein.

As shown in FIG. 11, an information processing system 101 of a system 200 can be communicatively coupled with the data processing module 150 and a group of client or other devices, or coupled to a presentation device for display at any location at a terminal or server location. According to this example, at least one processor 102, responsive to executing instructions 107, performs operations to communicate with the processing module 150 via a bus architecture 208, as shown. The at least one processor 102 is communicatively coupled with main memory 104, persistent memory 106, and a computer readable medium 120. The processor 102 is communicatively coupled with an Analysis & Data Storage 115 that, according to various implementations, can maintain stored information used by, for example, the data processing module 150 and more generally used by the information processing system 200. In some embodiments, the data processing module 150 can be coupled to one or more sensors 152 as needed. Such sensors can be barcode scanners, fingerprint readers, proximity sensors, microphones, cameras, video cameras, location sensors, motion detectors, scales, biometric reading devices (e.g., iris scanners, facial recognition scanners, voice detection devices) and other devices as contemplated herein. Optionally, this stored information can be received from the client or other devices. For example, this stored information can be received periodically from the client devices and updated or processed over time in the Analysis & Data Storage 115. Additionally, according to another example, a history log can be maintained or stored in the Analysis & Data Storage 115 of the information processed over time. The data processing module 150, and the information processing system 200, can use the information from the history log such as in the analysis process and in making decisions related to a particular user's access or for a particular procedure or process in accordance with the embodiments.

The computer readable medium 120, according to the present example, can be communicatively coupled with a reader/writer device (not shown) that is communicatively coupled via the bus architecture 208 with the at least one processor 102. The instructions 107, which can include instructions, configuration parameters, and data, may be stored in the computer readable medium 120, the main memory 104, the persistent memory 106, and in the processor's internal memory such as cache memory and registers, as shown.

The information processing system 200 includes a user interface (or interfaces) 110 that comprises a user output interface 112 and user input interface 114. Examples of elements of the user output interface 112 can include a display, a speaker, one or more indicator lights, one or more transducers that generate audible indicators, and a haptic signal generator or any of the interfaces illustrated or discussed with respect to the figures or elsewhere in the application. Examples of elements of the user input interface 114 can include a keyboard, a keypad, a mouse, a track pad, a touch screen, a touch pad, a microphone that receives audio signals, a camera, a video camera, a CT-Scanner, or any other scanner that scans images. Some user inputs can be sensors or vice-versa. The received audio signals or scanned images, for example, can be converted to electronic digital representations and stored in memory, and optionally can be used with corresponding voice or image recognition software executed by the processor 102 to receive user input data and commands, or to receive test data for example. The voice recognition software can be used to enter or check off items on a checklist or to vote in a pending vote and further provide data or text entry allowing the user to enter data as needed.

A network interface device 116 is communicatively coupled with the at least one processor 102 and provides a communication interface for the information processing system 100 to communicate via one or more networks 108. The networks 108 can include wired and wireless networks, and can be any of local area networks, wide area networks, or a combination of such networks. For example, wide area networks including the internet and the web can inter-communicate the information processing system 100 with other one or more information processing systems that may be locally, or remotely, located relative to the information processing system 100. It should be noted that mobile communications devices, such as mobile phones, Smart phones, tablet computers, lap top computers, and the like, which are capable of at least one of wired and/or wireless communication, are also examples of information processing systems within the scope of the present disclosure. The network interface device 116 can provide a communication interface for the information processing system 100 to access the at least one database 117 according to various embodiments of the disclosure. The database 117 can store a list of user nodes corresponding to a particular admin node for example.

The instructions 107, according to the present example, can include instructions for voting, tallying, monitoring, instructions for analyzing, instructions for retrieving and sending information and related configuration parameters and data. It should be noted that any portion of the instructions 107 can be stored in a centralized information processing system or can be stored in a distributed information processing system, i.e., with portions of the system distributed and communicatively coupled together over one or more communication links or networks.

FIGS. 1-10 illustrate examples of systems, methods or process flows, according to various embodiments of the present disclosure, which can operate in conjunction with the information processing system 200 of FIG. 11.

1. A method, comprising:
identifying a plurality of rules defining a private blockchain that stores records or documents on a cloud storage by a predefined set of nodes;
creating a private blockchain block comprising the plurality of rules defining the private blockchain;
receiving a selection from a user node of the predefined set of nodes of a record or of a document for modification associated with the private blockchain, wherein the selection creates a flagged record or a flagged document;
receiving a vote tally from among the predefined set of nodes;
modifying the record or document based on a consensus of the vote tally based on the plurality of rules defining the private blockchain by adding an update block to the blockchain;
broadcasting the update block to each node in the predefined set of nodes;
adding the update block to a local blockchain of each node in the predefined set of nodes; and
presenting the flagged document or the flagged record as modified by the update block.

2. The method of claim 1, wherein a client viewer of the private blockchain displays the update block which points to an underlying modified record or an underlying modified document.

3. The method of claim 1, wherein a client viewer of the private blockchain when requested to display the update block causes the client viewer to hide the flagged document or hide the flagged record.

4. The method of claim 1, wherein the private blockchain has a database file structure including a block header, a sequence number, a date and time a block was created, a previous block hash value, a current block hash value, a document type, and a document path on a local storage or on the cloud storage.

5. The method of claim 1, wherein the private blockchain has a database file structure including a block header, a sequence number, a date and time a block was created, a previous block hash value, a current block hash value, a document name, a document hash, and a document type.

6. The method of claim 1, wherein the method further comprising having a hash of the block independent of a hash of an underlying document stored in association with the blockchain.

7. The method of claim 1, wherein the method enables the presentation of an underlying document or an underlying record using a user interface of a client viewer.

8. An apparatus, comprising:
One or more processors configured to:
recognize a plurality of rules defining and creating a private blockchain that stores documents on a cloud storage by a predefined set of nodes;
receive a selection from a user node of the predefined set of nodes of a document for modification associated with the private blockchain, wherein the selection creates a flagged document;
receive a vote tally from among the predefined set of nodes;
modify the document based on a consensus of the vote tally based on the plurality of rules defining the private blockchain by adding an update block to the private blockchain;
discard the update block if there is a lack of the consensus of the vote tally;
receive a broadcast of the update block on the user node if the consensus is met;
add the update block to a local blockchain; and
presenting the flagged document as modified by the update block which causes the cloaking of the flagged document.

9. The apparatus of claim 8, wherein the apparatus is a client device selected among a smartphone, a laptop computer, a desktop computer, or a notepad computer.

10. The apparatus of claim 8, wherein the apparatus further comprises a user interface in the form of a client viewer of the private blockchain that is configured to hide the flagged document without deleting the document on the cloud storage.

11. The apparatus of claim 8, wherein the private blockchain has a database file structure including a block header, a sequence number, a date and time a block was created, a previous block hash value, a current block hash value, and two or more a document type, and a document path on a local storage, a document path on the cloud storage, a document name, and a document hash.

12. The apparatus of claim 8, wherein the apparatus performs a hash of the block independent of a hash of an underlying document stored in association with the blockchain.

13. The apparatus of claim 8, wherein the apparatus further includes a user interface of a client viewer enabling the presentation of an underlying document.

14. A non-transitory computer readable storage medium configured to store at least one instruction that when executed by one or processors causes the one or more processors to perform:
identifying a plurality of rules defining a private blockchain that stores records or documents on a cloud storage by a predefined set of nodes;
creating a private blockchain block comprising the plurality of rules defining the private blockchain;
receiving a selection from a user node of the predefined set of nodes of a record or of a document for modification associated with the private blockchain, wherein the selection creates a flagged record or a flagged document;
receiving a vote tally from among the predefined set of nodes;
modifying the record or document based on a consensus of the vote tally based on the plurality of rules defining the private blockchain by adding an update block to the blockchain;
broadcasting the update block to each node in the predefined set of nodes;
adding the update block to a local blockchain of each node in the predefined set of nodes; and
presenting the flagged document or the flagged record as modified by the update block.

15. The non-transitory computer readable storage medium of claim 14, further configured to have a client viewer of the private blockchain displaying the update block which points to an underlying modified record or an underlying modified document.

16. The non-transitory computer readable storage medium of claim 14, further configured to cause a client viewer to hide the flagged document or hide the flagged record of the private blockchain when requested to display the update block.

17. The non-transitory computer readable storage medium of claim 14, wherein the private blockchain has a database file structure including a block header, a sequence number, a date and time a block was created, a previous block hash value, a current block hash value, a document type, and a document path on a local storage or on the cloud storage.

18. The non-transitory computer readable storage medium of claim 14, wherein the private blockchain has a database file structure including a block header, a sequence number, a date and time a block was created, a previous block hash value, a current block hash value, a document name, a document hash, and a document type.

19. The non-transitory computer readable storage medium of claim 14, further configured to have a hash of the block independent of a hash of an underlying document stored in association with the blockchain.

20. The non-transitory computer readable storage medium of claim 14, further configured to have the presentation of an underlying document or an underlying record using a user interface of a client viewer.
